(19) United States
(12) Patent Application Publication
(10) Pub. No.: US 2017/0323322 A1
(43) Pub. Date: Nov. 9, 2017

(54) Fortune Cookies With Promotional Messages

(71) Applicant: Fred Herz Patents, LLC, Milton, WV (US)

(72) Inventors: Tracy Herz, Milton, WV (US); Frederick S.M. Herz, Milton, WV (US)

(21) Appl. No.: 15/587,065

(22) Filed: May 4, 2017

Related U.S. Application Data
(60) Provisional application No. 62/332,181, filed on May 5, 2016.

(51) Int. Cl. G06Q 30/02; A21D 13/40

(52) U.S. Cl. CPC G06Q 30/0224; A21D 13/40

(57) ABSTRACT

A fortune cookie includes a cookie and printed messages that promote the theme of the restaurant providing the fortune cookie and that provide promotional material that enhances customer loyalty (and enhanced business for the restaurant) through promotional advertising, giveaways, and the like. For example, a fortune cookie with a Southern country theme is formed from cornbread, shortbread, red velvet, pecan pie, or other American Southern or country-style flavor and includes messages on one side with a home-spun country theme and promotional materials on the other side. The promotional materials may include free items such as candy from a country store for the children and giveaways or discounts correlated with the point of sale on purchases from the country store or for future food purchases from the restaurant. The promotions also may be directed to cross-promotions with other retail and online establishments.

### CROSS-REFERENCE TO RELATED APPLICATIONS

The present application claims priority to U.S. Provisional Patent Application No. 62/332,181, filed May 5, 2016. The content of that patent application is hereby incorporated by reference in its entirety.

### TECHNICAL FIELD

The present application relates to fortune cookies including “fortunes” that promote products and/or include messages related to the theme of the restaurant that provides the cookies.

### BACKGROUND

The roots of the traditional fortune cookie are in the American frontier, specifically San Francisco in 1894. These tiny, inexpensive cookies have been provided at the end of Chinese meals for over a century. However, the fortune cookies distributed by Chinese restaurants with the check are not particularly interesting, and have no intrinsic value. Typically, the cookies are bland and the messages inside relay a Confucian saying or other witticism. In recent years, the reverse sides of the messages also may include “lucky” numbers and/or a simple statement in the Chinese language. However, other than a minimal entertainment value, traditional fortune cookies do not serve a purpose. It is desired to provide fortune cookies with messages that promote the theme of the restaurant providing the fortune cookies and provide promotional material that will enhance customer loyalty (and enhanced business for the restaurant) through promotional advertising, giveaways, and the like.

### SUMMARY

A fortune cookie is provided that includes messages that promote the theme of the restaurant providing the fortune cookie and that provide promotional material that enhances customer loyalty (and enhanced business for the restaurant) through promotional advertising, giveaways, and the like. For example, a fortune cookie specifically designed for Cracker Barrel, an American chain of combined restaurant and gift store with a Southern country theme headquartered in Lebanon, Tennessee, is formed from cornbread and includes messages on one side with a home-spun country theme and promotional materials on the other side. In addition to cornbread, the fortune cookie may be flavored as shortbread, red velvet, pecan pie, honey and biscuits, molasses, or other American Southern or country-style flavor. The promotional materials may include free items such as candy from the country store for the children and giveaways or discounts on purchases from the country store or for future food purchases from the restaurant. The promotions also may be directed to cross-promotions with other retail and online establishments.

It is contemplated that the fortune cookies described herein may be adapted for use in other styles of restaurants with different themes. For example, matzoh fortune cookies may be provided in Jewish delis, pita bread fortune cookies in Greek restaurants, tortilla fortune cookies in Mexican restaurants, Portuguese sweetbread fortune cookies in Spanish or Portuguese restaurants, rice cake fortune cookies in Japanese restaurants, gingerbread or chocolate chip cookie fortune cookies in ice cream parlors, etc. The messages would match the theme of the restaurant and the promotions would be designed to enhance customer loyalty through giveaways and promotions suited to the restaurant. The cookies would be distributed with the bill in the restaurant and would include coupons or discounts correlated with the point of sale, thus driving traffic through the store on the way out as well as coupons or discounts that would encourage return visits.

### BRIEF DESCRIPTION OF THE DRAWINGS

The features and advantages of the invention will become apparent from the following detailed description with relation to the accompanying figures, of which:

FIG. 1 illustrates a sample cornbread fortune cookie in an exemplary embodiment.

FIG. 2 illustrates packaging for the cornbread fortune cookie of FIG. 1.

FIGS. 3A, 3B, 3C, and 3D illustrate sample fortunes for the fortune cookie of FIG. 1.

FIG. 4 is a cartoon illustrating how the cornbread fortune cookie would be used to promote customer loyalty and additional sales in a Cracker Barrel restaurant with an Old Country Store.

### DETAILED DESCRIPTION OF ILLUSTRATIVE EMBODIMENTS

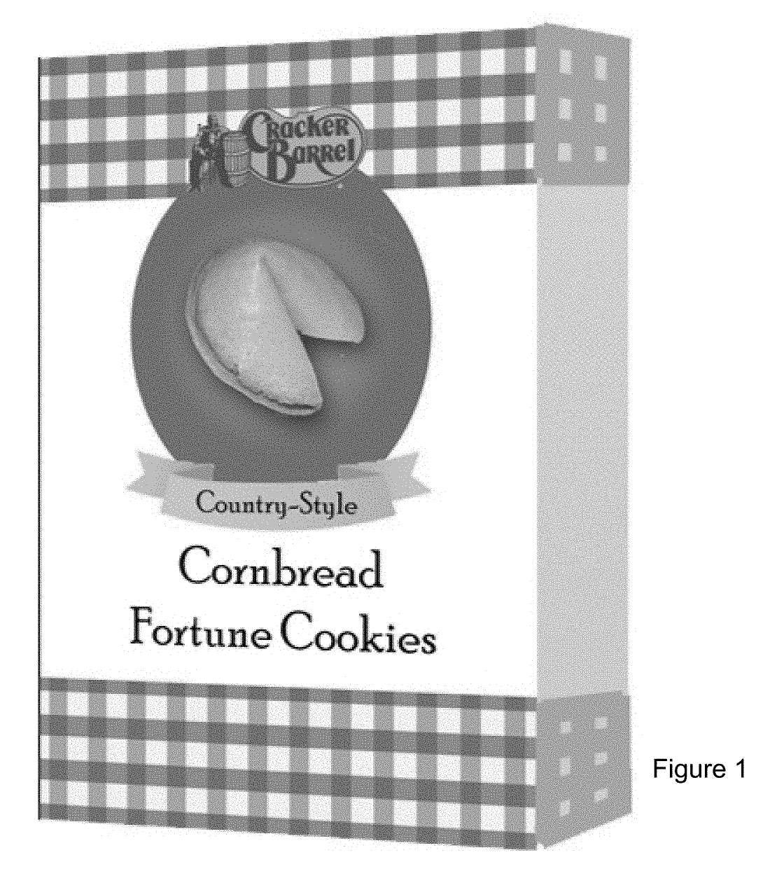

Certain specific details are set forth in the following description with respect to FIGS. 1-4 to provide a thorough understanding of an embodiment of the invention. Those of ordinary skill in the relevant art will understand that they can practice other embodiments of the invention without one or more of the details described below. Also, while various methods are described with reference to steps and sequences in the following disclosure, the description is intended to provide a clear implementation of embodiments of the invention, and the steps and sequences of steps should not be taken as required to practice the invention.

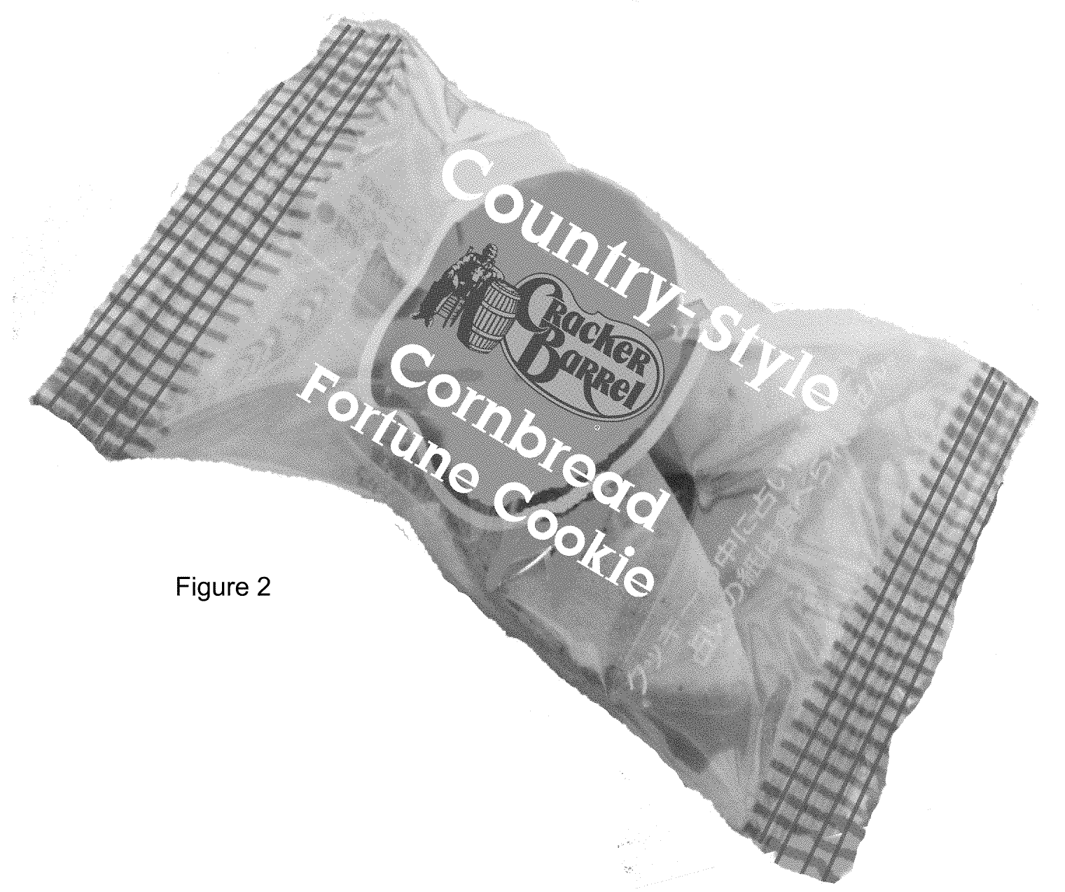

FIG. 1 illustrates a sample cornbread fortune cookie in an exemplary embodiment. The illustrated fortune cookie has been specifically designed for use by Cracker Barrel Old Country Stores, but it will be appreciated by those skilled in the art that the fortune cookie may be made with other flavors such as shortbread, red velvet, pecan pie, honey and biscuits, molasses, or other American Southern or country-style flavor and from other edible materials such as matzoh, pita bread, tortillas, Portuguese sweetbread, rice cake, gingerbread, chocolate chip cookies, etc. The cookie is designed to be hollow inside for holding a fortune and is distributed at a restaurant with the bill. Such cookies are available from Wonton Foods or Baily, Inc., for example. As illustrated in FIG. 2, such fortune cookies may be placed in packaging suitable for retail sales by the restaurant, or may be sold in bulk to the restaurant for distribution by the restaurant.

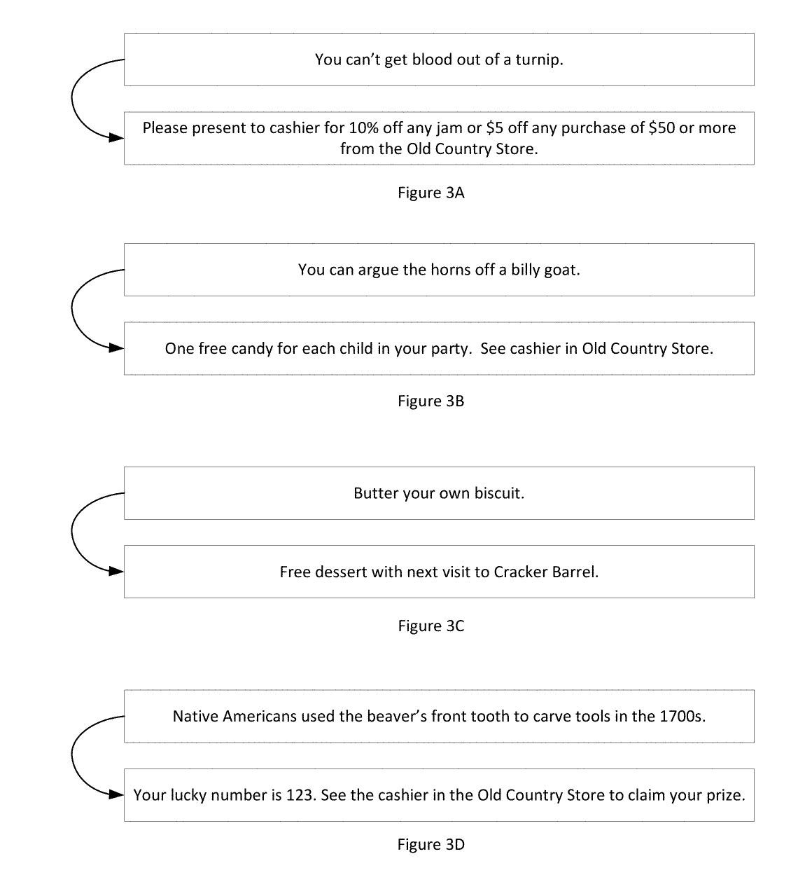

In exemplary embodiments, the fortune cookies include printed messages that promote the theme of the restaurant providing the fortune cookies. The printed message may include an educational fact or expression of culture or folk wisdom. For example, in the case of Cracker Barrel, the messages provide multicultural American historic value by providing pithy home-spun country sayings that bring back fond memories of old family sayings passed down through generations. As illustrated in FIGS. 3A, 3B, 3C, and 3D, the messages may include a southern colloquial fortune on one side and/or a historical fact about country living as well as a “prize” on the other side. The prize may be specified or may be represented by a number that can be tracked, such as a Cracker Barrel Lucky Number, and reimbursed at the register or other point of sale. At a minimum, the prize can be 10 percent off the clearance rack, 10 percent off in the online store, or a discount off of a Cracker Barrel product such as maple syrup or jam at the register. At most, the prize might be a dollar credit toward any purchase over a specified amount in the Old Country Store, a piece of candy, a package of DC Comics Superhero Cotton Candy, or a discount or giveaway for restaurant items purchased during a subsequent visit. In the case of a restaurant like Cracker Barrel that has an associated store, the discount or giveaway may be correlated with the point of sale for purchases from the associated store. The message thus motivates the guest to spend additional time, and money, on the way out of Cracker Barrel, in the Old Country Store, as much as on the way in. The fortune cookies themselves also may be sold as novelty items or collectables.

Those familiar with the frontier and Southern dialect of the Southern country theme promoted by Cracker Barrel will recognize that this dialect is rich with both expressive, entertaining and amusing expressions that can fit the 10 word “fortune” format as well as the fascinating history that keeps guests returning to such stores. In exemplary embodiments, a roster of over 5000 expressions may be in rotation at any given time. The following are a few examples of the vast array of colorful Southern, country and frontier expressions that actually bear traces of Elizabethan English that are still found in the rural parts if America today:

You can't get blood out of a turnip.

If the shoe fits, wear it.

Butter your own biscuit.

Sparks are going to fly at the square dance!

You enter a room with bells on.

To get ahead, get the bee out of your bonnet!

You can argue the horns off a billy goat.

In two shakes of a lamb's tail, your dream comes true!

Similarly, there is a vast array of Southern country facts that may also be provided on such fortune cookies. The following are a few examples of the country-style facts that could be presented on the reverse side of the country-style cornbread fortune cookie designed for sale and use by Cracker Barrel:

Native Americans used the beaver's front tooth to carve tools in the 1700s.

Early American women tied pockets on the outside of their skirts.

Phrenologists analyzed a person's character by examining the location of the bumps on their head.

Bone marrow was an early delicacy that required a special instrument to extract.

Also, as shown in FIGS. 3A, 3B, 3C, and 3D, the messages may include any desired combination of sayings, country facts, promotions, and discounts as desired by the restaurant owner. The prizes are ideally designed to extend the brand experience and to otherwise advance and enhance the theme of the restaurant. In the case of Cracker Barrel, which includes an associated Old Country Store, the promotions would drive sales both in the restaurant and in the Old Country Store by giving a Cracker Barrel Country-Style Cornbread Fortune Cookie to each guest with the presentation of the check. The promotions may also cross-sell retail and online products from Cracker Barrel or designated partners.

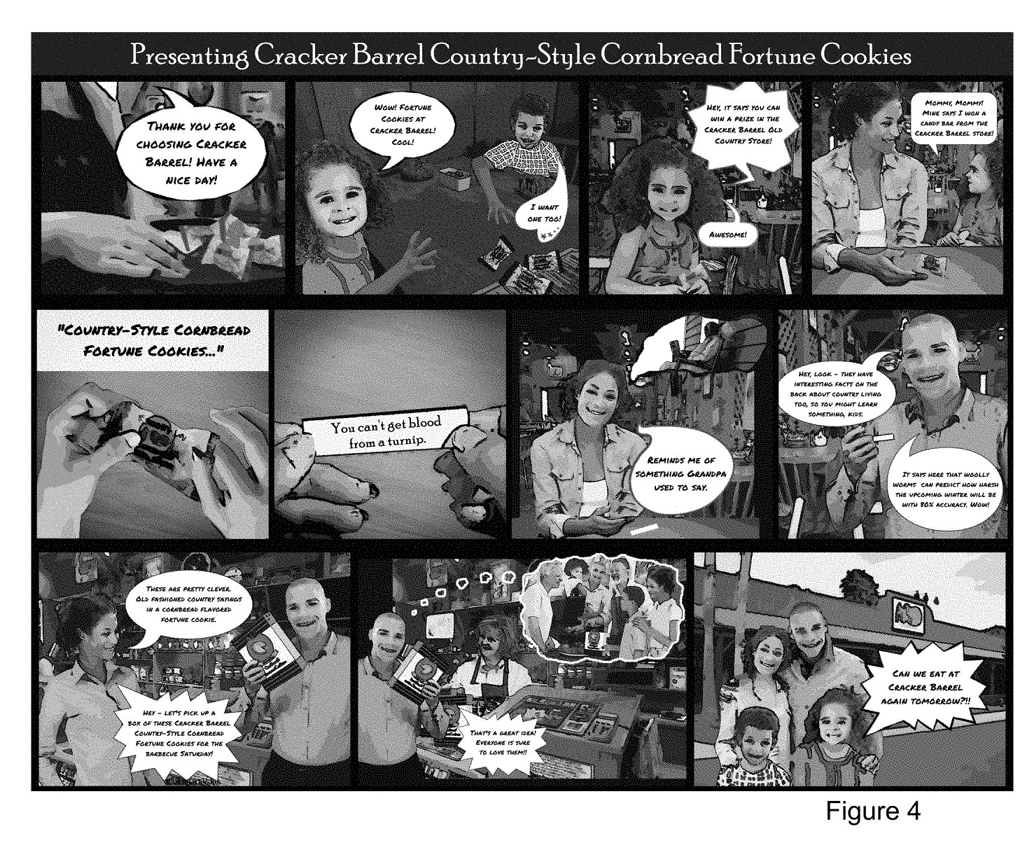

The cartoon of FIG. 4 illustrates the presentation of a fortune cookie as described herein. As illustrated, at the end of the customer's meal, the customer receives a Country Cornbread Frontier Fortune cookie. On the front is the colloquial fortune from the local color language used in early rural America. For example:

“You can't get blood out of a turnip.”

A promotion specific to Cracker Barrel such as this would be on the reverse:

“Take 10 additional percent off any item on the clearance rack”

Or

“Use this number to take 10 percent off of any purchase in our online store.”

Or

“You won a Hershey bar.”

Or

Take 20% off our Cracker Barrel Country Maple Syrup

Or

Your lucky number is 123. See the casher in the Old Country Store to claim your prize.

Etc.

On the back, there is a fact about early American Rural Life. For example:

“The incisor of a beaver was used by 17th century native Americans as a tool to cut stone.”

These promotions are designed to cause the customers to spend more time in the store after or during the process of paying the bill and/or to provide the incentive for a return visit.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. For example, the fortune cookies themselves may be made from edible materials appropriate for the culture or theme of the restaurant and the associated messages and promotions would be adapted accordingly. The promotions could be redeemed in person in the store or in a related or cross-promoted online store as desired. It is understood, therefore, that the scope of the present disclosure is not limited to the particular examples and implementations disclosed herein, but is intended to cover modifications within the spirit and scope thereof as defined by the appended claims and any and all equivalents thereof

What is claimed:

1. A fortune cookie including a cookie including therein a printed message with a theme adapted to the culture and theme of a restaurant in which the fortune cookie is provided and a promotional message that entitles the recipient to a free gift or discount on an item in the restaurant or an item in an associated or cross-marketed retail or online store.

2. The fortune cookie of claim 1, wherein the cookie is formed from edible material appropriate for the culture or theme of the restaurant.

3. The fortune cookie of claim 2, wherein the cookie is formed from cornbread.

4. The fortune cookie of claim 2, wherein the cookie has at least one of the following flavors: shortbread, red velvet, pecan pie, honey and biscuits, and molasses.

5. The fortune cookie of claim 1, wherein the printed message includes an educational fact or expression of culture or folk wisdom.
